(19) United States
(12) Patent Application Publication
(10) Pub. No.: US 2008/0134293 A1
(43) Pub. Date: Jun. 5, 2008

(54) METHOD AND SYSTEM FOR PROVIDING DISTRIBUTED APPLICATIONS

(76) Inventor: James Storm, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(21) Appl. No.: 11/564,970

(22) Filed: Nov. 30, 2006

(51) Int. Cl. H04L 9/32; G06F 15/16

(52) U.S. Cl. 726/4; 709/217

(57) ABSTRACT

A method of providing at least two distributed applications to a user comprising the steps of receiving a request from said user for said at least two distributed applications; retrieving said at least two distributed applications from a plurality of distributed servers; translating said at least two distributed applications into a HyperText Markup Language (HTML) format; and forwarding said translated applications to said user.

### FIELD OF THE INVENTION

The present invention relates generally to accessing applications located on multiple remote servers. More particularly, the present invention relates to a method and system for providing distributed applications.

### BACKGROUND OF THE INVENTION

With the creation of the Internet, this has allowed consumers of the Internet to more easily access documents and applications which were not electronically available to them previously. A new pipeline has been provided for users to access information. Users may now access remote servers, located anywhere in the world, to retrieve documents and applications for execution or access on their personal home computers or laptops.

Currently, when a user wishes to access content and/or applications which are stored in servers in remote locations, the user transmits a request to the server requesting the desired content/application and then waits for the server to respond to the request by forwarding the requested content/application.

In many cases, if the user wishes to retrieve multiple applications on a single server, this is performed using a single request from the user to the server. However, when applications are located on different servers, or the applications are distributed, this retrieval typically requires one request per application and therefore, when multiple applications are desired, multiple requests are required.

Furthermore, some distributed applications are required to interact with another application to provide an improved or upgraded application. By requesting each application separately, there is still a need to integrate the applications together prior to execution or use of the application. This integration process may be quite time consuming.

It is, therefore, desirable to provide a novel method and system for providing distributed applications.

### SUMMARY OF THE INVENTION

It is an object of the present invention to obviate or mitigate at least one disadvantage of previous methods and systems for providing distributed applications.

In a first aspect, the present invention provides a method of providing at least two distributed applications to a user comprising the steps of receiving a request from the user for the at least two distributed applications; retrieving the at least two distributed applications from a plurality of distributed servers; translating the at least two distributed applications into a HyperText Markup Language (HTML) format; and forwarding the translated applications to the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic view of a first embodiment of a system for accessing distributed applications;

FIG. 2 is a flowchart showing an embodiment of a method of accessing distributed applications.

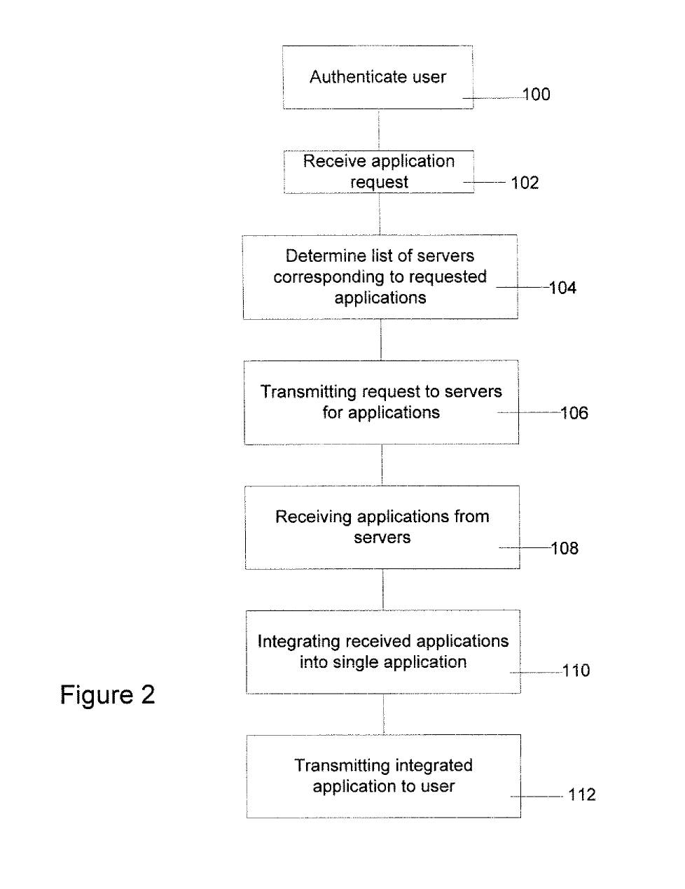

### DETAILED DESCRIPTION

Generally, the present invention provides a method and system for providing distributed applications. Once a user requests these applications, the distributed applications are accessed and retrieved and then integrated with each other to build a single application which is provided via a user interface to the individual requesting the applications.

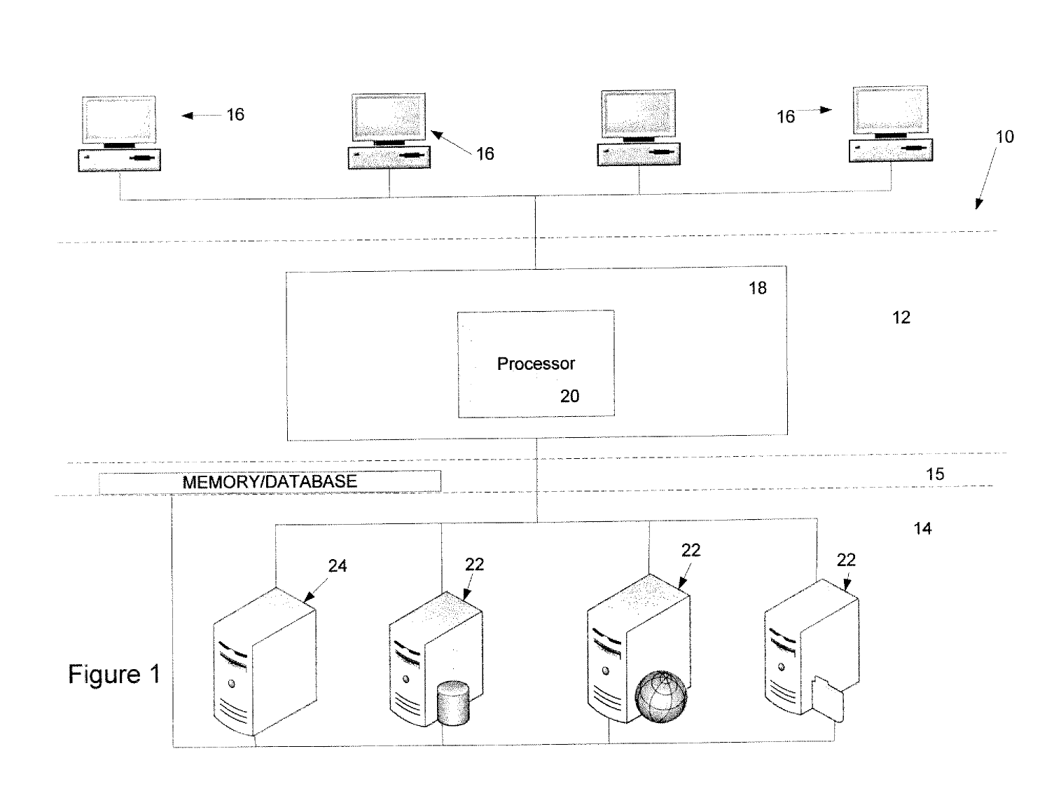

Turning to FIG. 1, a schematic diagram of a system for accessing distributed applications is shown. The system 10 includes a presentation layer 12, an application layer 14 and a data layer 15. The application layer 14 is in communication with the presentation layer 12 and the data layer 15, however, the presentation layer 12 and the data layer 15 do not communicate in the preferred embodiment. Users (as illustrated by computers 16) wishing to access the system 10 access the presentation layer 12 via an Internet Browser, such as Internet Explorer™ or Mozilla Firefox™.

The presentation layer 12 includes a web server 18 which houses a processor 20 for receiving application requests, managing authentication and building a user interface. Each of these tasks will be described in more detail below. The application layer 14 includes a plurality of servers 22 (located through the world) which store various applications in remote locations. These distributed applications are available for access by any one of the users 16. Examples of available applications include, but are not limited to, document management, collaboration tools, simple and advanced searches, calendaring, news feeds, research tools and blogs. The data layer 15 includes a database or memory 17 which is used to store all of the user data.

In operation, a user 16 accesses the system 10 via the Internet browser stored on their associated computer. By entering a URL address associated with the web server 18, the user 16 is able to access the system. After accessing the web server 18, the user 16 is required to be authenticated (step 100).

One known authentication method is via a username and password, as will be understood by one skilled in the art. After receiving the user's username and password entry, the processor 20 transmits this authentication information to a membership server 24 in the application layer 14 which verifies the authentication information. If the authentication is successful, the processor 20 transmits an encrypted cookie to the user's computer 16 so that the computer may be uniquely identified by the system 10. For each subsequent application request transmitted by the user (with their associated computer), the computer 16 also submits the encrypted cookie so that the user does not have to be authenticated each time they access the system 10. The processor 20 receives the cookie and transmits a user lookup request to the membership server 24 to determine and authenticate the identity of the user so that the request may be performed. Authentication of a user allows the processor 20 to access the application layer 14 with the user request. The data layer 15, with respect to this authentication, stores the user's information in the memory 17 while the application layer 14 receives the user information (supplied by the user via the presentation layer 12) and validates the user information for the data layer 15.

In the current embodiment, the authentication scheme is seen as stateless which means that the system does not maintain a list of users that are currently authenticated.

After a positive authentication, the user provides a request, to the processor 20 (step 102), for distributed applications which are stored in the servers 22 in the application layer 14. The processor 20 may also receive the application request prior to authenticating the user but the user must be authenticated before the processor 20 accesses the servers 22 in the application layer 14.

After receiving the request, the processor 20, preferably executing a software module, reviews the request and determines which servers 22 to access in accordance with the application or applications requested by the user (step 104). In the preferred embodiment, a listing of all the servers 22 (and associated information such as IP address and stored applications) in the application layer 14 is stored in the web server 18. Alternatively, the web server may access this information from a database. In yet another embodiment, the request may include the IP address of the server(s) 22 they wish to access along with the requested application.

After determine the relevant servers 22, the processor 20 communicates with the servers 22 in the application layer 14 to request the applications (step 106) and to ensure that the application layer 14 is accessed in accordance with pre-defined criteria. In this embodiment, the presentation layer 12 is able to obfuscate the identifies of the servers 22 in the application layer 14 which mitigates the risk of malicious users and prevents direct access to the servers 22 for the users.

Communication between the presentation layer 12 and the application layer 14 is performed using XML (Extensible Markup Language) over HTTP (Hypertext Transfer Protocol) such that communication from the presentation layer 12 to the application layer 14 is via an HTTP request while communication from the application layer 14 to the presentation layer 12 is via XML.

Therefore, after making the HTTP request to the servers 22 in the application layer 14, the servers 22 receive the request(s) and transmit the applications back to the processor 20 in the web server 18 using XML. Once the various applications are received by the processor 20 (step 108), the applications are preferably integrated into a single application (step 110) and transmitted to the user via an XSLT (Extensible Stylesheet Language Transformations) file (step 112). The XSLT file transforms the XML response from the application layer 14 into HTML so that the web browser on the user's computer may be able to view and display the requested applications in an integrated format.

An advantage of the invention is that by separating the system 10 into the three separate layers, namely the presentation layer 12, the application layer 14 and the data layer 15, a more intelligent distribution of processing power is experienced. The servers 22 in the application layer 14 and the database/memory/server in the data layer 15 are much more powerful and have a higher fault tolerance than the web server 18 in the presentation layer 12. Furthermore, the current system architecture allow for the reconfiguration of processing power as necessary, as the number of users increases and user patterns evolve. It will be understood that although only one web server is illustrated in the preferred embodiment, multiple web servers 18 are contemplated and implemented in relation to the number of users accessing the system 10.

Furthermore, security between the layers is achieved by only allowing the user to access the presentation layer 12 of the system 10. As the user does not have any access to the application 14 or data layers 15, the user is unable to negatively affect the data and/or applications stored in these layers. Moreover, as communication from the presentation layer 12 to the application layer 14 is over HTTP, this communication may be encrypted using secure sockets (HTTPS). This also prevents administrators from monitoring traffic between the layers. Furthermore, a firewall may be implemented between the presentation and application layers so that if the presentation layer 12 is compromised in any manner, the firewall provides a secondary security measure preventing users from accessing the application 14 or data layers 15.

A further advantage of the current invention is the benefit of load balancing. As traffic increases over the system (i.e. an increase of application requests), further hardware, such as a second web server 18, may be added to the system 10 to handle the load. This is possible since the system operates with a stateless authentication scheme and also the use of HTTP communication between the presentation layer and the application layer.

Another advantage of the invention is that the system is designed so that it, or any of its constituent layers, may be clustered. Clustering and load balancing go hand-in-hand. Servers are clustered so that the load can be spread over multiple pieces of hardware. Aspects of the system that lend itself to clustering and load balancing are the stateless authentication and the use of well known and established communication protocols between the presentation and application layers.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of providing at least two distributed applications to a user comprising the steps of:
receiving a request from said user for said at least two distributed applications;
retrieving said at least two distributed applications from a plurality of distributed servers;
translating said at least two distributed applications into a HyperText Markup Language (HTML) format; and
forwarding said translated applications to said user.

2. The method of claim 1 wherein said step of retrieving comprises the steps of:
determining, from said plurality of distributed servers, a list of servers associated with said at least two distributed applications;
transmitting a request to each server in said list of servers for said at least two distributed applications; and
receiving said at least two distributed applications from said servers.

3. The method of claim 2 wherein said step of transmitting a request is performed using HyperText Transfer Protocol (HUP).

4. The method of claim 2 wherein said step of receiving said at least two distributed applications is performed over Extensible Markup Language (XML).

5. The method of claim 1 wherein said step of translating is performed via an Extensible Language transformation (XSLT).

6. The method of claim 1 wherein said request is from an Internet browser.

7. The method of claim 2 wherein said step of determining comprises the steps of:
comparing each of said at least two distributed applications to a list associating each of said at least two distributed applications with a server; and
obtaining a list of servers.

8. The method of claim 7 further comprising the step of:
retrieving a fully qualified domain name of said servers from said list of servers.

9. The method of claim 1 further comprising the steps, occurring before said step of receiving, of:
receiving authorization information from said user; and
authenticating said user.

10. The method of claim 9 wherein said authorization information is a username and password.

11. The method of claim 9 wherein said authorization information is an encrypted cookie.

12. The method of claim 11 wherein said step of authenticating said user comprises the step of:
accessing a membership system to retrieve user information associated with said encrypted cookie.

13. The method of claim 1 wherein said step of retrieving is performed using secure sockets over HTTPS.

14. The method of claim 1 wherein said step of retrieving is performed via a firewall.

15. The method of claim 1 further comprising the steps, occurring after said step of receiving, of:
receiving authorization information from said user; and
authenticating said user.
